(19) United States
(12) Patent Application Publication
(10) Pub. No.: US 2013/0004194 A1
(43) Pub. Date: Jan. 3, 2013

(54) IMAGE FORMING APPARATUS AND NON-TRANSITORY COMPUTER READABLE STORAGE MEDIUM

(76) Inventors: Yoshinori Shirasaki, Osaka (JP); Tatsuya Miyadera, Osaka (JP); Tomohiro Ohshima, Osaka (JP)

(21) Appl. No.: 13/583,797

(22) PCT Filed: Mar. 10, 2011
(86) PCT No.: PCT/JP2011/056319

§ 371 Date: Sep. 10, 2012

(30) Foreign Application Priority Data
Mar. 11, 2010 (JP) 2010-054990

(51) Int. Cl. G03G 15/00

(52) U.S. Cl. 399/71

(57) ABSTRACT

An image forming apparatus includes an image forming unit that forms developer images in different colors on image carriers; a first transfer unit that transfers the developer images onto an endless conveying body; a second transfer unit that transfers the developer images onto a recording medium; pattern detecting units that irradiate a given developer pattern formed on the endless conveying body with a light beam and detect reflected light from the pattern; a cleaning unit that cleans developer images adhered to the second transfer unit; and a control unit that controls each of the units. The pattern detecting units are arranged between the second transfer unit and the image carrier on the most upstream side from the second transfer unit in a rotation direction of the endless conveying body. The control unit changes a cleaning time of the cleaning unit based on a detection result of the pattern detecting units.

### TECHNICAL FIELD

The present invention relates to an image forming apparatus such as a copying machine, a printer, a facsimile, and a digital MFP in which a plurality of image carriers are arranged in a juxtaposed manner along the moving direction of an endless conveying body and an image is formed by a first transfer unit primarily transferring images formed on the respective image carriers onto the endless conveying body and further by a second transfer unit secondarily transferring the primarily transferred images onto a recording medium, and to a non-transitory computer readable storage medium storing therein a cleaning time optimization control program that causes a computer execute an optimization control of the execution time for cleaning the second transfer unit executed by the image forming apparatus.

### BACKGROUND ART

In a tandem type color image forming apparatus, four image forming units for each of four colors are used to form a color image. To accurately make image forming positions of these colors overlap with one another, a color alignment pattern in each color is formed, the image position of each color is detected with a detecting unit such as an optical sensor, and the position of each image where the images overlap with one another is calculated to make correction.

The color alignment pattern passes a detecting position along with the conveyance of an intermediate transfer belt (or a conveying belt). After the detection, the toner on the belt is scraped off with a cleaning blade and retrieved as waste toner. In an intermediate transfer system, a secondary transfer roller is arranged between the detecting position and the cleaning blade, and some toner before cleaning adheres on the secondary transfer roller. The residual or adhered toner adheres on the rear surface of a sheet as stains, thereby deteriorating image quality. To eliminate the stains on the rear surface of the sheet by the secondary transfer roller, cleaning is performed by applying bias to the secondary transfer roller to attract the toner towards the intermediate transfer belt and retrieving the toner with the cleaning blade.

Such cleaning operation leads to an increase in user downtime and thus, the technologies to optimize the cleaning time by detecting the residual toner have already been known such as the one disclosed in Japanese Patent Application Laid-open No. 2003-84582.

Japanese Patent Application Laid-open No. 2003-84582 discloses that it is aimed to clean the toner that falls onto the surface of the transfer roller and adheres on the surface of the transfer roller when a toner image passes through the transfer roller section, and that the amount of the toner adhered on the transfer roller is assumed from a density detection signal (an output from an optical sensor) of a toner pattern image T and then, the duration or a voltage of bias to apply to the transfer roller in the same polarity as the toner is established to clean the transfer roller.

However, in the known toner detecting methods including the invention disclosed in Japanese Patent Application Laid-open No. 2003-84582, the toner on the intermediate transfer belt is not directly observed at the position immediately after the secondary transfer roller, but is indirectly detected, and the methods presume the residual toner based on the detection result, whereby it takes time to obtain the detection result.

An object of the present invention is to shorten the time to detect toner and to further optimize the cleaning time by directly detecting the toner on the intermediate transfer belt.

### DISCLOSURE OF INVENTION

According to an aspect of the present invention, there is provided an image forming apparatus that includes an image forming unit that includes a plurality of image carriers arranged juxtaposed along a moving direction of an endless conveying body and forms developer images in different colors in electrophotographic process on the image carriers; a first transfer unit that transfers the developer images formed on the respective image carriers onto the endless conveying body; a second transfer unit that includes a rotating body that transfers the developer images transferred on the endless conveying body onto a recording medium; a plurality of pattern detecting units that irradiate a given developer pattern formed on the endless conveying body with a light beam and detect a state of reflected light from the pattern; a cleaning unit that applies bias to the second transfer unit to clean developer images adhered to the second transfer unit while the endless conveying body is rotating; and a control unit that controls each of the units. The pattern detecting units are arranged between the second transfer unit and the image carrier on the most upstream side from the second transfer unit in a rotation direction of the endless conveying body. The control unit changes a cleaning time of the cleaning unit based on a detection result of the pattern detecting units.

According to another aspect of the present invention, there is provided a non-transitory computer readable storage medium having a cleaning time optimization control program stored therein for optimizing a cleaning time executed by a control unit of an image forming apparatus. The image forming apparatus includes an image forming unit that includes a plurality of image carriers arranged juxtaposed along a moving direction of an endless conveying body and forms developer images in different colors in electrophotographic process on the image carriers, a first transfer unit that transfers the developer images formed on the respective image carriers onto the endless conveying body, a second transfer unit that includes a rotating body that transfers the developer images transferred on the endless conveying body onto a recording medium, a plurality of pattern detecting units that irradiate a given developer pattern formed on the endless conveying body with a light beam and detect a state of reflected light from the pattern, a cleaning unit that applies bias to the second transfer unit to clean developer images adhered to the second transfer unit while the endless conveying body is rotating, and the control unit that controls each of the units. The cleaning time optimization control program causes a computer to execute changing the cleaning time of the cleaning unit based on a pattern detection result of the pattern detecting units arranged between the second transfer unit and the image carrier on the most upstream side from the second transfer unit in a rotation direction of the endless conveying body.

### BRIEF DESCRIPTION OF DRAWINGS

FIG. 1 is a block diagram schematically illustrating the overall structure of an image forming system including an image forming apparatus according to an embodiment of the present invention;

FIG. 2 is a schematic diagram of the image forming apparatus illustrating the detail of the structure of a tandem type image forming units for respective colors juxtaposed along an intermediate transfer belt;

FIG. 3 is a schematic diagram illustrating an internal structure of an exposing unit;

FIG. 4 is a magnified view of a density sensor as a pattern detecting unit;

FIG. 5 is a schematic diagram illustrating a detecting structure to carry out toner pattern detection by a position sensor as a pattern detecting unit and the density sensor;

FIG. 6 is a diagram illustrating an example of correction patterns formed on the intermediate transfer belt;

FIG. 7 is a diagram for explaining the principle of detecting color alignment patterns depicted in FIG. 6;

FIG. 8 is a schematic block diagram illustrating the structure of a positional deviation correction circuit that processes detected data to calculate the amount of correction necessary for the positional deviation correction;

FIG. 9 is a diagram for explaining the method of detecting the amount of residual toner;

FIG. 10 is a flowchart illustrating a setting procedure of a threshold level; and

FIG. 11 is a flowchart illustrating a processing procedure of the positional deviation correction.

### BEST MODE FOR CARRYING OUT THE INVENTION

In the present invention, a position sensor is arranged facing an intermediate transfer belt at the downstream of a secondary transfer roller and, by optically detecting the surface of the intermediate transfer belt, the residual toner is directly detected with the position sensor at the time of cleaning the secondary transfer roller to perform optimization control of the execution time for the cleaning operation carried out when correcting positional alignment. Exemplary embodiments of the invention in detail will be described with reference to drawings below.

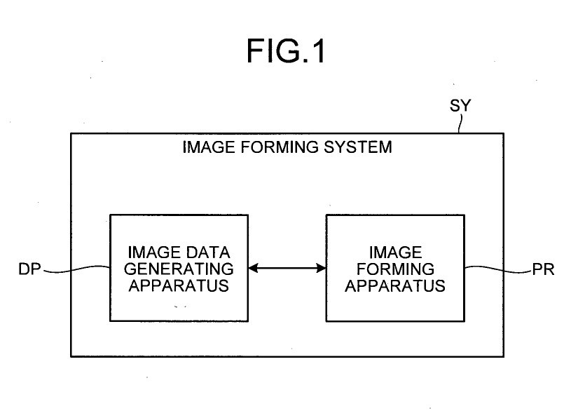

FIG. 1 is a block diagram illustrating the overall structure of an image forming system including an image forming apparatus according to a present embodiment. In FIG. 1, an image forming apparatus PR according to the present embodiment is a four color tandem type color image forming apparatus and, as depicted in the block diagram in FIG. 1, an image data generating apparatus DP and the image forming apparatus PR constitute an image forming system SY.

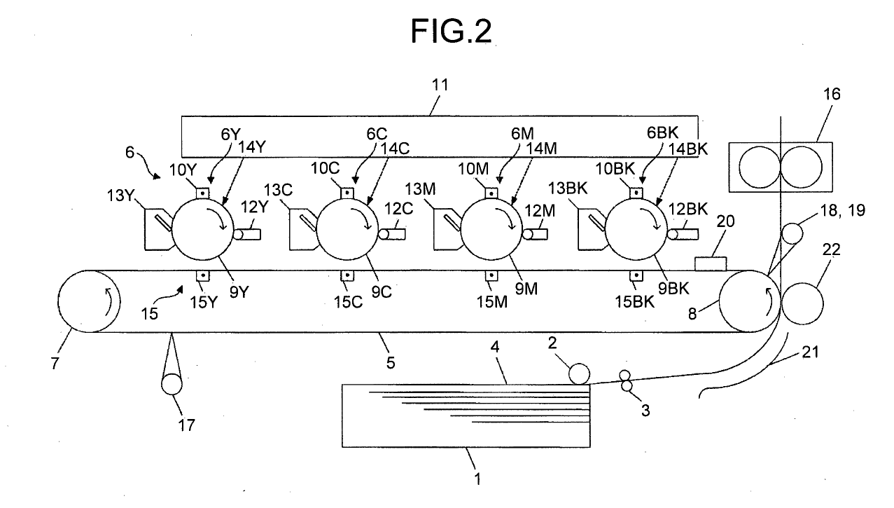

The image forming apparatus in detail, as depicted in FIG. 2, is structured as a tandem type with image forming units for the respective colors juxtaposed along an intermediate transfer belt. Along the intermediate transfer belt that conveys a sheet fed from a paper feed tray, a plurality of image forming units are arranged in sequence from the upstream side in the conveying direction of the intermediate transfer belt.

When forming an image, the sheet held in the paper feed tray is sent out in sequence starting from the top, attracted onto the intermediate transfer belt by the action of electrostatic attraction, and transferred with a toner image by the intermediate transfer belt and a secondary transfer roller.

Each of the image forming units is structured with a photosensitive element, a charging unit, an exposing unit, a developing unit, a photosensitive element cleaner, a neutralization unit, and the like.

FIG. 2 is a schematic diagram illustrating the structure of the image forming apparatus according to the present embodiment. In FIG. 2, the image forming apparatus according to the present embodiment is of a tandem type image forming apparatus in indirect transfer method with image forming units for the respective colors juxtaposed along the intermediate transfer belt that is an endless moving unit. The image forming apparatus is provided at least with a paper feed tray 1, an exposing unit 11, a plurality of image forming units 6, an intermediate transfer belt 5, a transfer unit (primary transfer unit) 15, a secondary transfer roller (secondary transfer unit) 22, and a fixing unit 16.

The intermediate transfer belt 5 electrostatically attracts and conveys a sheet (recording sheet) 4 separated and fed from the paper feed tray 1 by a paper feeding roller 2 and a separating roller 3. The image forming units 6 have image forming units (electrophotography processing units) 6BK, 6M, 6C, and 6Y for four colors of black (BK), magenta (M), cyan (C), and yellow (Y) arranged in that order from the upstream along the rotational direction of the intermediate transfer belt 5. These image forming units 6BK, 6M, 6C, and 6Y have a common internal structure except for the color of toner images formed being different. The image forming unit 6BK forms an image in black, while the image forming unit 6M forming one in magenta, the image forming unit 6C forming one in cyan, and the image forming unit 6Y forming one in yellow.

In the following explanation, the structure common to each of the colors will be generally explained omitting the suffixes BK, M, C, and Y indicative of the color, in place of explaining for each color.

The intermediate transfer belt 5 is made of an endless belt and tightly stretched between a drive roller 7 and a driven roller 8. The drive roller 7 is rotary driven by a driving motor not depicted and moves in the direction of an arrow indicated in FIG. 2 (counter-clockwise direction in FIG. 2).

The image forming unit 6 is provided with an photosensitive drum 9 as a photosensitive element, and a charging unit 10, a developing unit 12, a transfer unit 15, a photosensitive drum cleaner 13, a neutralization unit (not depicted) and the like are arranged along the outer circumference of the photosensitive drum 9. Between the charging unit 10 and the developing unit 12, an exposing section that is irradiated with a laser light 14 radiated from the exposing unit 11 is arranged. The exposing unit 11 irradiates each exposing section of the photosensitive drum 9 of each image forming unit 6 with the laser light 14 of an exposure beam corresponding to the color of the image formed by the respective image forming unit 6. The transfer unit 15 is arranged so as to face the photosensitive drum 9 through the intermediate transfer belt 5.

In a tandem type image forming apparatus of an indirect transfer method, primary transfer is made onto the intermediate transfer belt 5 and the overlapped images in four colors are secondarily transferred collectively onto the sheet to form a full color image on the sheet.

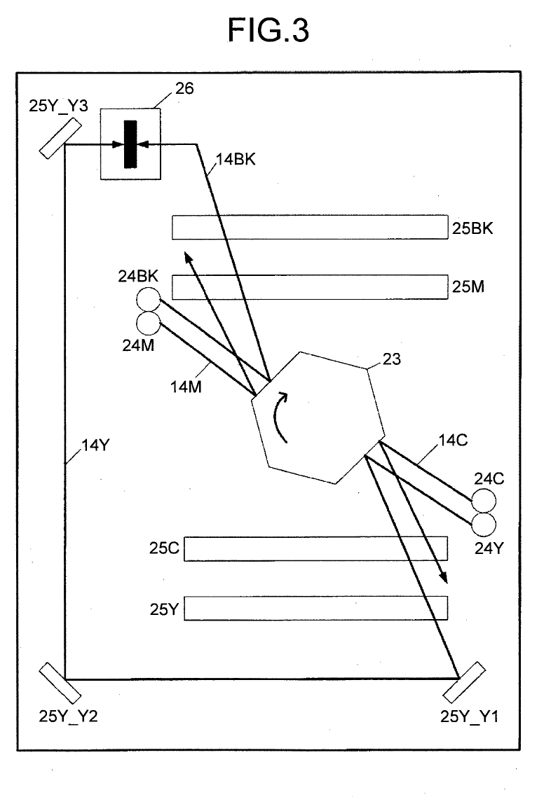

FIG. 3 is a diagram schematically illustrating the internal structure of the exposing unit 11. Laser lights 14BK, 14M, 14C, and 14Y of exposure beams for the respective colors of an image are radiated from laser diodes 24BK, 24M, 24C, and 24Y of light sources, respectively. The laser lights radiated go through optical systems 25BK, 25M, 25C, and 25Y to have their optical paths adjusted and then scan the respective surfaces of the photosensitive drums 9BK, 9M, 9C, and 9Y via a rotary polygon mirror 23. The rotary polygon mirror 23 is a hexahedral polygonal mirror and its rotation makes the exposure beams scan for one line in the main-scanning direction per each surface of the polygon mirror. A single piece of polygon mirror serves to scan for the four laser diodes 24 of the light sources. The fact that the laser lights 14 are separated to the exposure beams of two colors each with the laser lights 14BK and 14M and with the laser lights 14C and 14Y and are scanned using opposing reflecting surfaces of the rotary polygon mirror 23 makes it possible to expose four different photosensitive drums 9 simultaneously. The optical systems 25 are each constituted by an f-θ lens that aligns reflected light in an equal distance and a deflecting mirror that deflects the laser light.

A synchronization detection sensor 26 is arranged outside of the image area in the main-scanning direction and detects the laser lights 14BK and 14Y for each scanning of one line to adjust the timing of the start of the exposure in image forming. The fact that the synchronization detection sensor 26 is arranged on the optical system 25BK side makes the laser light 14Y incident on the synchronization detection sensor 26 via synchronization detection reflecting mirrors 25Y_Y1, 25Y_Y2, and 25Y_Y3. The timings of writing for the laser lights 14M and 14C cannot be adjusted by the synchronization detection sensor 26. Therefore, the start timing of the exposure for magenta is matched to the start timing of the exposure for black, and the start timing of the exposure for cyan is matched to the start timing of the exposure for yellow to align the positions of respective colors.

When forming image, the outer circumferential surface of the photosensitive drum 9BK is uniformly charged by the charging unit 10BK in the dark and then, exposed by the laser light 14BK corresponding to an image in black from the exposing unit 11 to form an electrostatic latent image on the surface of the photosensitive drum 9BK. The developing unit 12BK makes black toner adhere to the electrostatic latent image to make the image visible. Consequently, a toner image in black is formed on the photosensitive drum 9BK.

The toner image is transferred onto the intermediate transfer belt 5 at the position where the photosensitive drum 9BK makes contact with the intermediate transfer belt 5 (primary transfer position) by the action of the transfer unit 15BK. By the transfer, an image of the black toner is formed on the intermediate transfer belt 5. The photosensitive drum 9BK that is completed to transfer the toner image is, after unnecessary residual toner on its outer circumferential surface is removed by the photosensitive drum cleaner 13BK, then neutralized by a neutralization unit (not depicted) and waits for a subsequent image forming.

The intermediate transfer belt 5 with the toner image in black thus transferred by the image forming unit 6BK is conveyed to the subsequent image forming unit 6M. Meanwhile, in the image forming units 6M, 6C, and 6Y, by the similar image forming process to that of the image forming unit 6BK, toner images in magenta, cyan, and yellow are formed on the photosensitive drums 9M, 9C, and 9Y with respective deviations in transfer timings by the transfer units 15. These toner images are then transferred onto the black image transferred on the intermediate transfer belt 5 in sequence overlapping one on top of the other. Accordingly, an image in full color is formed on the intermediate transfer belt 5. The overlapping full color image formed on the intermediate transfer belt 5 is then secondarily transferred onto the sheet 4 fed from the paper feed tray 1 at the position of the secondary transfer roller 22, whereby the image in full color is formed on the sheet 4. The full color image formed on the sheet 4 is fixed by the fixing unit 16 and then, the sheet 4 is discharged to the outside of the image forming apparatus.

In the color image forming apparatus thus structured, due to errors in distances among the shafts of the photosensitive drums 9BK, 9M, 9C, and 9Y, errors in parallelism of the photosensitive drums 9BK, 9M, 9C, and 9Y, an error in the arrangement of the deflection mirror in the exposing unit 11, errors in the timings of writing the electrostatic latent images to the photosensitive drums 9BK, 9M, 9C, and 9Y, and the like, the toner images of respective colors may not overlap to one another at the position where they are supposed to overlap causing positional deviation among the respective colors. The component of such positional deviation in the respective colors is known to include mainly skew, registration deviation in the sub-scanning direction, magnification errors in the main-scanning direction, and registration deviation in the main-scanning direction.

To eliminate such deviation, it is necessary to correct the positional deviation of toner images of the respective colors. The correction of positional deviation is carried out to align the positions of the images in three colors of M, C, and Y with respect to the position of the image in BK. In the present embodiment, as depicted in FIG. 2, at the downstream of the image forming unit 6Y and at the upstream of the secondary transfer roller 22, a density sensor 17 is provided and, at the upstream of the image forming unit 6BK and at the downstream of the secondary transfer roller 22, position sensors 18 and 19 are provided facing the intermediate transfer belt 5 as image detecting units that detect a toner pattern. These sensors 17, 18, and 19 detecting the toner pattern are of optical sensors of a reflective type.

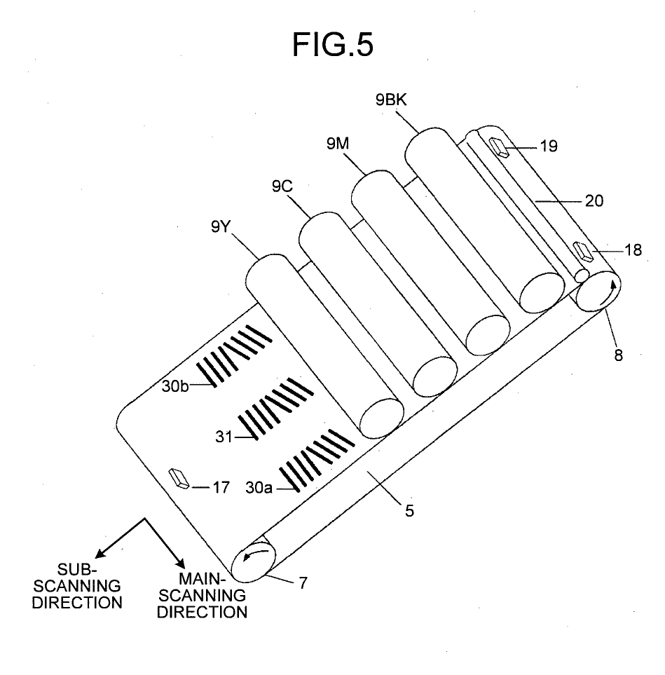

To calculate the information of an amount of positional deviation or an amount of toner adhered necessary for positional deviation correction or density correction, later described patterns 30a, 30b, and 31 as indicated in FIG. 5 are formed on the intermediate transfer belt 5, and the sensors 17, 18, and 19 read the correction patterns 30a, 30b, and 31 of the respective colors. After the detection, a cleaning unit 20 cleans and removes the patterns from the intermediate transfer belt 5.

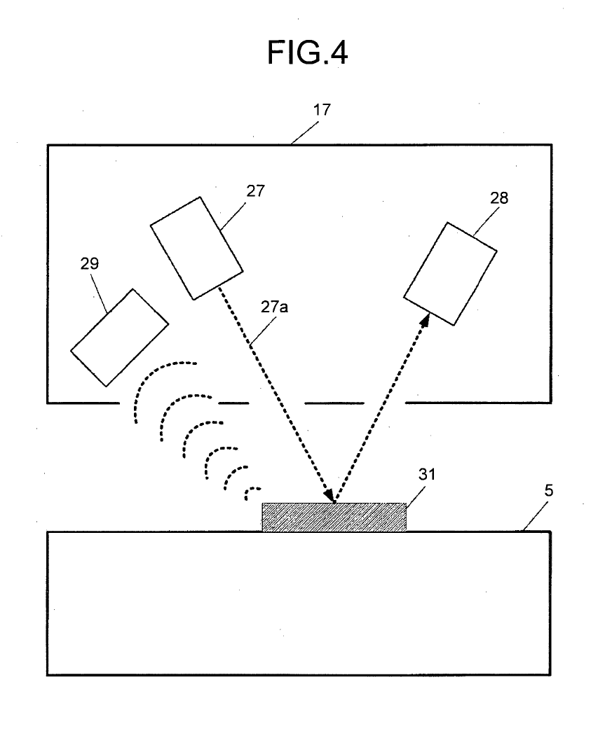

FIG. 4 is an enlarged diagram of the density sensor 17 and FIG. 5 is a diagram illustrating the detecting structure for detecting the toner pattern by the position sensors 18 and 19 and the density sensor 17 indicating the positional relation of the intermediate transfer belt 5, the correction patterns 30, and the sensors 17, 18, and 19. The position sensors 18 and 19 are each provided with a light-emitting element 27 and a regularly reflected light-receiving element 28. The density sensor 17 is further provided with a diffusely reflected light-receiving element 29. More specifically, the position sensors 18 and 19 are structured as the structure of the density sensor 17 depicted in FIG. 4 with the diffusely reflected light-receiving element 29 being omitted. The position sensors 18 and 19 are arranged at both ends in the main-scanning direction. The rows of color alignment patterns (positional deviation correction pattern) 30a and 30b are formed for each of the position sensors 18 and 19, and the density pattern (density correction pattern) 31 is formed only for the density sensor 17 in the center.

In FIG. 4, the density sensor 17 is provided with the light-emitting element 27, the regularly reflected light-receiving element 28, and the diffusedly reflected light-receiving element 29. The light-emitting element 27 irradiates the density pattern 31 formed on the intermediate transfer belt 5 with a light beam 27a, and the regularly reflected light-receiving element 28 receives its reflected light containing regularly reflected light component and diffusedly reflected light component. This makes it possible for the density sensor 17 to detect the density pattern 31. When detecting the density pattern 31, the regularly reflected light-receiving element 28 receives the reflected light containing the regularly reflected light component and the diffusedly reflected light component, while the diffusedly reflected light-receiving element 29 receives the diffusedly reflected light.

The position sensors 18 and 19 detect the positional deviation correction patterns 30a and 30b. The position sensors 18 and 19 are arranged at the both ends in the main-scanning direction as depicted in FIG. 5, and the rows of the color alignment patterns 30a and 30b are formed, respectively. In FIG. 5, a single set of pattern rows is depicted that is required minimum for obtaining the amounts of various positional deviations for the respective colors.

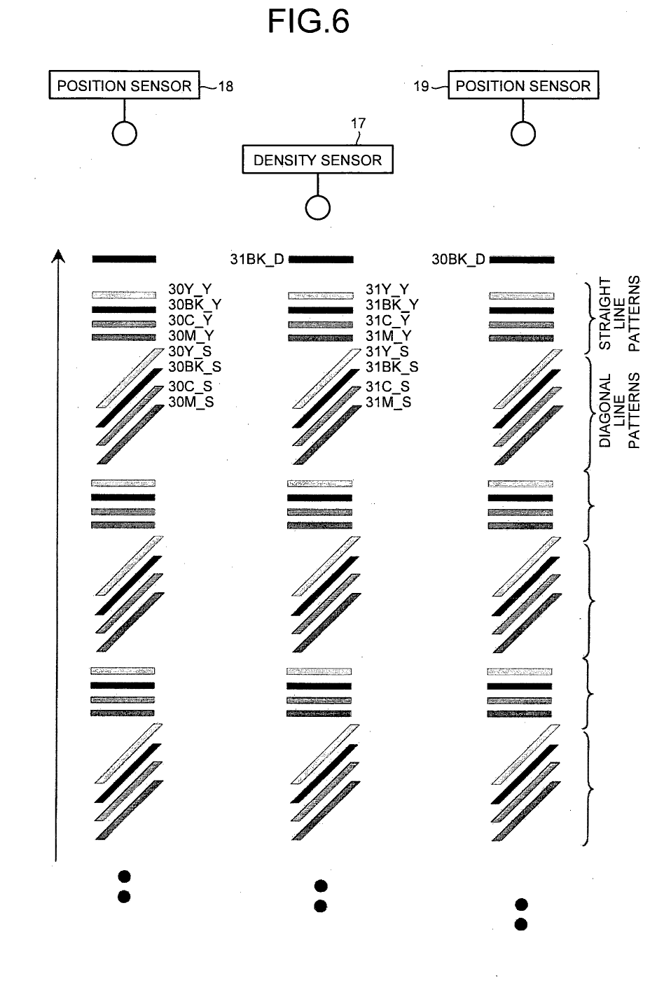

FIG. 6 is a diagram indicating examples of correction patterns 30a, 30b, and 31. The positional deviation correction patterns 30a and 30b are each constituted by a total of eight pattern rows of straight line patterns 30BK_Y, 30M_Y, 300_Y, and 30Y_Y, and diagonal line patterns 30BK_S, 30M_S, 30C_S, and 30Y_S in four colors of BK, M, C, and Y as a set of pattern rows. The diagonal line patterns 30BK_S, 30M_S, 30C_S, and 30Y_S are all diagonal rising from bottom left to top right (in FIG. 6, the right end is the top position and the left end is the bottom position in planar view with respect to the sub-scanning direction).

These pattern rows are formed for each of the two position sensors 18 and 19 and further, a plurality of sets of pattern rows are formed in the sub-scanning direction. In the following explanation, the color alignment patterns are collectively represented by the reference numeral 30 and the density pattern is represented by the reference numeral 31.

Similarly, the density pattern 31 is also constituted by a total of eight pattern rows of straight line patterns 31BK_Y, 31M_Y, 31C_Y, and 31Y_Y, and diagonal line patterns 31BK_S, 31M_S, 31C_S, and 31Y_S in four colors of BK, M, C, and Y as a set of pattern rows. The diagonal line patterns 31BK_S, 31M_S, 31C_S, and 31Y_S are all diagonal rising from bottom left to top right similarly to the positional deviation correction patterns 30a and 30b. These pattern rows are formed as the same as those for the position sensors 18 and 19 and further, a plurality of sets of pattern rows are formed in the sub-scanning direction.

In addition, the color alignment patterns 30 and the density pattern 31 have detection timing correction patterns 30BK_D and 31BK_D, respectively, at the beginning of the patterns. The sensors 17, 18, and 19 detect the detection timing correction patterns 30BK D and 31BK D just before detecting the straight line patterns 30BK_Y, 30M_Y, 30C_Y, 30Y_Y, 31BK_Y, 31M_Y, 31C_Y, and 31Y_Y, the diagonal line patterns 30BK_S, 30M_S, 30C_S, and 30Y_S, and the diagonal line patterns 31BK_S, 31M_S, 31C_S, and 31Y_S. By detecting the time it takes for the detection timing correction patterns to reach the position of the image detecting units from the start of forming the patterns and by calculating errors from the theoretical values, an appropriate correction is made. This allows the straight line patterns 30BK_Y, 30M_Y, 30C_Y, 30Y_Y, 31BK_Y, 31M_Y, 31C_Y, and 31Y_Y, and the diagonal line patterns 30BK_S, 30M_S, 30C_S, 30Y_S, 31BK_S, 31M_S, 31C_S, and 31Y _S to be detected at their appropriate timings.

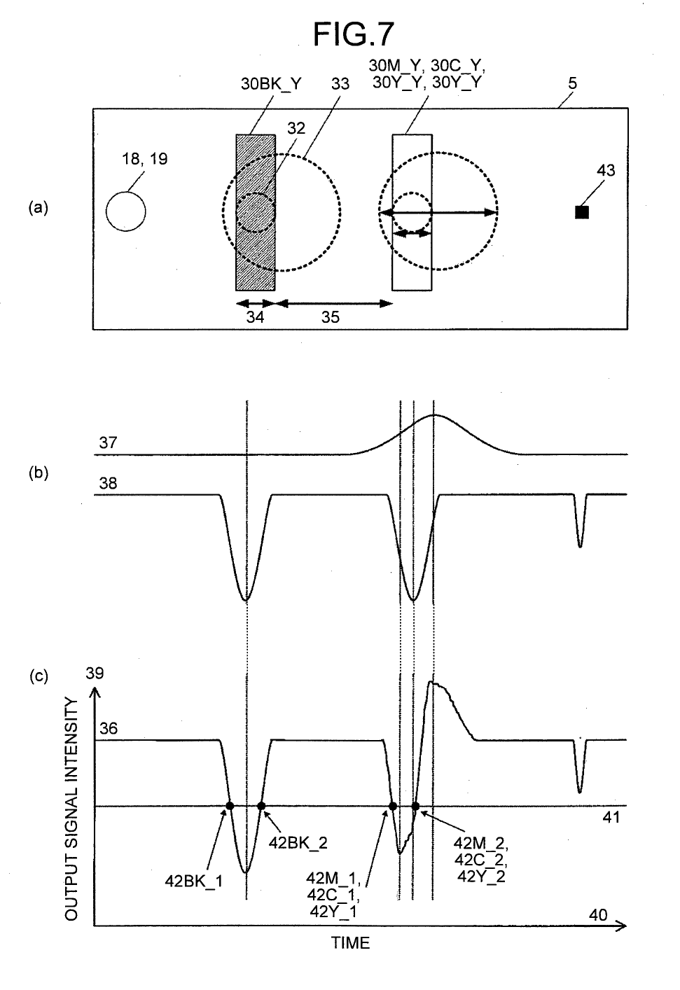

FIG. 7 is a diagram for explaining the detection principle of the color alignment patterns depicted in FIG. 6. Upper part (a) of FIG. 7 illustrates the relation of the correction patterns, a spot diameter of the irradiated light, and a spot diameter of the regularly reflected light-receiving element, Middle part (b) of FIG. 7 illustrates an example of the relation of the diffusely reflected light component and the regularly reflected light component in a light-receiving signal of the correction patterns, and lower part (c) of FIG. 7 illustrates an output signal of the regularly reflected light-receiving element and a way to obtain a midpoint of the correction patterns. On the intermediate transfer belt 5, as depicted in

FIG. 6, the color alignment patterns 30 in respective colors of BK, M, C, and Y are formed. In upper part (a) of FIG. 7, the reference numeral 34 represents the pattern width of the straight line patterns 30BK_Y, 30M_Y, 30C_Y, and 30Y_Y in the sub-scanning direction, the reference numeral 35 represents the distance between the adjacent straight line patterns 30BK_Y and 30M_Y, the reference numeral 33 represents the spot diameter of the light-emitting element 27 radiating the color alignment patterns 30 at the position of the patterns, and the reference numeral 32 represents the spot diameter of the detection by the regular reflected light-receiving element.

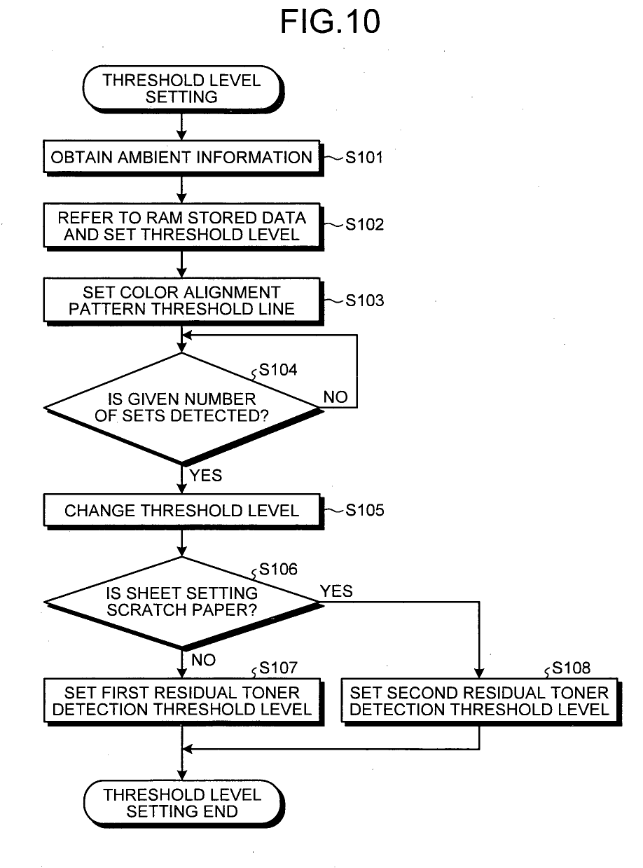

The light-emitting element 27 irradiates the color alignment patterns 30 on the intermediate transfer belt 5 with the light beam 27a. The output signal of the regularly reflected light-receiving element 28 is the reflected light from the intermediate transfer belt 5 and thus contains the regularly reflected light component and the diffusedly reflected light component. When the intermediate transfer belt 5 moves under such relationship, as illustrated in middle part (b) of FIG. 7, the light-receiving signals of the sensors 17, 18, and 19 have characteristics of the diffusely reflected light component indicated by the reference numeral 37 and that of the regularly reflected light component indicated by the reference numeral 38. In lower part (c) of FIG. 7, the reference numeral 36 indicates the output signal of the regularly reflected light-receiving element 28. In the lower part (c) of FIG. 7, the vertical axis of the chart indicates the intensity of the output signal of the regularly reflected light-receiving element 28 and the horizontal axis indicates time. A later described CPU 51 determines that the edges of the patterns 42BK_1 and 42BK_2, and 42M_1, 42C_1, and 42Y_1 and 42M_2, 42C_2, and 42Y_2 are detected at the respective positions where the detection waveform of the output signal 36 of the regularly reflected light-receiving element 28 of the position sensors 18 and 19 crosses a threshold line 41. Furthermore, the CPU 51 determines the image position with the average value of these two edge points. As for the intensity of the output signal, i.e., the intensity of the reflected light, of the regularly reflected light-receiving element 28 indicated in the lower part (c) of FIG. 7, a median value of the intensity, i.e., a half the intensity, between the intensity of the reflected light from the surface of the intermediate transfer belt 5 and the intensity of the reflected light from the pattern of the highest density is set, and this intensity of the reflected light is set as the threshold line 41. However, the fact that the position sensors 18 and 19 detecting the color alignment patterns 30 are arranged downstream of the secondary transfer roller 22 and the intermediate transfer belt 5 and the secondary transfer roller 22 are physically in contact results in a portion of the color alignment patterns on the intermediate transfer belt 5 being removed. Accordingly, the threshold level is set corresponding to that removal. The setting procedure of the threshold level will be described later with reference to FIG. 10.

In the middle part (b) of FIG. 7, the reference numeral 37 represents the diffusedly reflected light component of the light-receiving signal. The diffusedly reflected light component is reflected from the color alignment patterns 30M_Y, 300_Y, and 30Y_Y in M, C, and Y colors, but not reflected from the surface of the intermediate transfer belt 5 and the color alignment pattern 30BK_Y in BK. The reference numeral 38 represents the regularly reflected light component of the light-receiving signal. The regularly reflected light component is strongly reflected from the surface of the intermediate transfer belt 5, but not reflected from the pattern of any of the color alignment patterns 30 regardless of the color.

As can be understood from the output signal 36 of the regularly reflected light-receiving element 28 depicted in the lower part (c) of FIG. 7, when detecting the color pattern, by detecting the reflected light that is the regularly reflected light component mixed with the diffusedly reflected light component, the S/N ratio is deteriorated compared with that of detecting the BK pattern. To stably detect the edges of the pattern, the following process are carried out:

I) The light-emitting element 27 maintains the intensity of the light beam 27a at a constant value while executing a single round of the positional deviation correction and the adhered amount correction.
II) The intensity of the irradiating light is adjusted to an optimum value for each execution of the positional deviation correction and the adhered amount correction.
III) The irradiation intensity of the light beam 27a is determined such that the level of the regularly reflected light from the intermediate transfer belt 5 becomes a target value using the detection result of the regularly reflected light-receiving element 28 by irradiating a intermediate transfer belt 5 with the light beam 27a at various intensities while no patterns are present.
IV) The irradiation intensity of the LED of the light-emitting element 27 is adjusted by changing the frequency of a PWM waveform fed to a drive circuit.
V) When the adjustment time needs to be shortened, a fixed value is used continuously for the frequency of the PWM waveform to make the irradiation intensity of the light beam 27a constant without carrying out the adjustment.

The position sensors 18 and 19 can detect the color alignment patterns accurately by adjusting the alignment between the light-emitting element 27 and the regularly reflected light-receiving element 28. When the alignment is displaced by mechanical tolerance, errors in mounting, and the like, as can be seen from the middle part (b) of FIG. 7, the peak position of the waveform of the regularly reflected light component 38 from the straight line patterns 30BK_Y, 30M_Y, 30C_Y, and 30Y_Y of the respective colors and that of the waveform of the diffusedly reflected light component 37 differ from each other. More specifically, in the output signal from the regularly reflected light-receiving element 28 (waveform of the regularly reflected light component 38), the center point of the actual pattern of the pattern 30BK matches the peak position of the output signal, while the center point of the actual pattern of the patterns 30M, 30C, and 30Y differs from the peak position of the output signal (waveform of the regularly reflected light component 37).

As a result, an error occurs in the detecting position of the color pattern and thus, the accurate position cannot be detected. The deterioration of S/N ratio and the error in detection in color pattern detection become larger when the diagonal line patterns 30BK_S, 30M_S, 30C_S, and 30Y_S are detected than detecting the straight line patterns 30BK_Y, 30M_Y, 300_Y, and 30Y_Y.

Meanwhile, as depicted in the upper part (a) of FIG. 7, when there is a disturbance 43 such as a belt scratch and an adhered matter present on the intermediate transfer belt 5, such scratch and adhered matter may sometimes be detected in error as the positional deviation correction patterns 30. When the disturbance 43 is irradiated with the light beam 27a, compared with a smooth intermediate transfer belt 5, the reflection level of the regularly reflected light becomes low (see the middle part (b) of FIG. 7). If the reflection level of the disturbance 43 is lower than the threshold line 41, the sensors 17, 18, and 19 erroneously recognize the disturbance 43 as the detection of the positional deviation correction patterns 30. To avoid this, improving the S/N ratio and lowering the threshold line 41 when detecting the positional deviation correction patterns 30 are effective.

The positional deviation correction is carried out by the CPU 51 executing a given calculating process based on the output of the position sensors 18 and 19 using the color alignment patterns 30 depicted in FIG. 6. More specifically, by obtaining the image positions of the straight line patterns 30BK_Y, 30M_Y, 30C_Y, and 30Y_Y from the detection result of the color alignment patterns 30 depicted in FIG. 6 and by the CPU 51 executing a given calculating process, the amount of, registration deviation in the sub-scanning direction and skew can be obtained. Further, in addition to the image positions of the straight line patterns 30BK_Y, 30M_Y, 30C_Y, and 30Y_Y, by obtaining the image positions of the diagonal line patterns 30BK_S, 30M_S, 30C_S, and 30Y_S and by the CPU 51 executing a given calculating process, the magnification errors in the main-scanning direction and the amount of registration deviation in the main-scanning direction can be detected. The positional deviation correction is carried out based on these results.

As for the skew, for example, by adding a tilt to the deflection mirror in the exposing unit 11 or to the exposing unit 11 itself by an actuator, it can be corrected.

As for the registration deviation in the sub-scanning direction, it can be corrected, for example, by the control of the timing of writing the lines and of the plane phase of the polygon mirror. As for the magnification errors in the main-scanning direction, for example, the frequency of image writing is changed to correct it. As for the registration deviation in the main-scanning direction, it can be corrected by changing the timing of writing the main-scanning line.

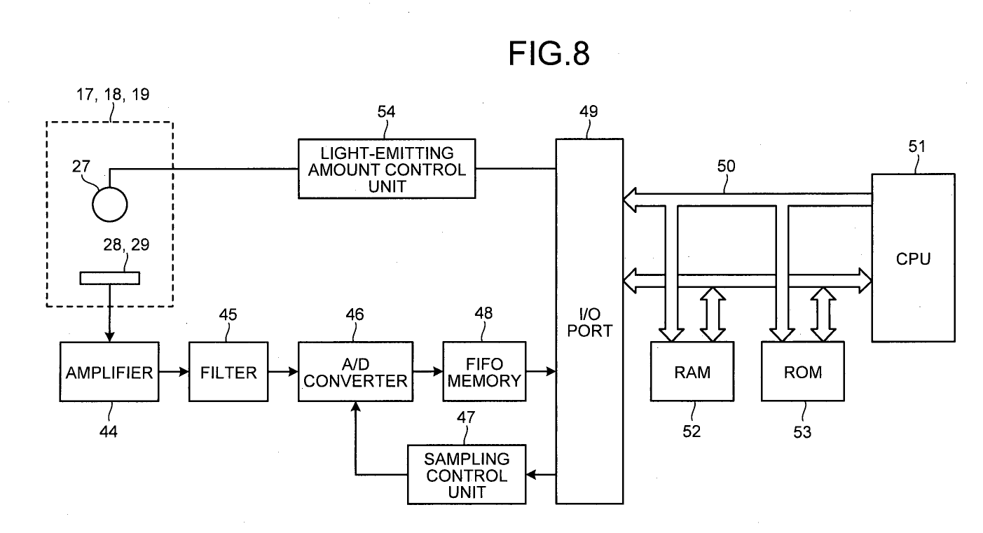

FIG. 8 is a block diagram illustrating the structure of the positional deviation correction circuit that carries out the processing of detected data to calculate the amount of correction necessary for the positional deviation correction. In FIG. 8, the positional deviation correction circuit is composed of a control circuit and a detection circuit, and the detection circuit is connected to the control circuit via an I/O port 49 of the control circuit.

The detection circuit is provided with the sensors 17, 18, and 19, an amplifier 44, a filter 45, an A/D converter 46, a sampling control unit 47, a FIFO memory 48, and a light-emitting amount control unit 54. The control circuit is composed of the CPU 51 connected with a RAM 52 and a ROM 53 via a data bus 50, and the I/O port 49 is connected to the data bus 50.

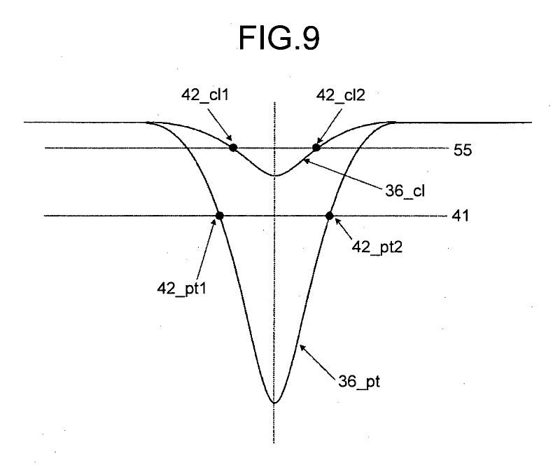

The output signals (see FIG. 9 which will be described later) obtained by the regularly reflected light-receiving elements 28 of the position sensors 18 and 19 are amplified by the amplifier 44, and only the signal component for line detection is passed through by the filter 45 and is converted from analog data to digital data by the A/D converter 46. The sampling of the data is controlled by the sampling control unit 47 and the sampled data is stored in the FIFO memory 48. After the detection of a set of positional deviation correction patterns 30 is finished, the stored data is loaded via the I/O port 49 through the data bus 50 to the CPU 51 and the RAM 52, and the CPU 51 carries out a given calculating process to obtain the amounts of various deviations described above.

The ROM 53 stores therein not only the program to calculate the amounts of the various deviations but also various programs for controlling an abnormality detection control, a positional deviation correction control, and the image forming apparatus itself according to the present embodiment. The CPU 51 monitors the detection signals from the regularly reflected light-receiving elements 28 at an appropriate timing so that the detection can reliably be made even if the deterioration or the like of the intermediate transfer belt 5 or the light-emitting elements 27 occurs by controlling the light-emitting amount control unit 54 to control the light-emitting amount such that the levels of the light-receiving signals from the regularly reflected light-receiving elements 28 always stay constant. The RAM 52 serves as a work area when the CPU 51 executes programs. Accordingly, the CPU 51 and the ROM 53 serve as a control unit that controls the operation of the whole of the image forming apparatus.

Forming and detecting the color alignment patterns 30 in such a manner allows the positional deviation correction among the respective colors to be carried out, whereby a high quality image can be output. In this case, to further reduce the color deviation and to obtain a high quality image, it is inevitable to reduce errors in color pattern detection and erroneous detection of the patterns. Accordingly, in the present embodiment, the adhered amount of toner per unit area of the color alignment patterns that makes the influence of diffusedly reflected light component from the color pattern (color alignment patterns 30) minimum is calculated. For that purpose, the density pattern 31 is used.

In the image forming apparatus, to obtain a high quality image without unevenness in density, it is necessary to make the adhered amount of toner per unit area constant when transferring the toner images of the respective colors onto a photographic paper. For this, the density correction is generally carried out in which the density patterns in respective colors are formed by varying a developing bias voltage and the amount of light of an exposure beam that control the adhered amount, and then the adhered amounts in respective colors are detected by a detecting unit such as a TM sensor and the developing bias voltage and the amount of light of the exposure beam for obtaining a target amount of toner adhered per unit area (density) are calculated. While such technologies are disclosed, for example, in Japanese Patent No. 3667971, and are not directly relevant to the present invention, their explanations are omitted here. However, as described in the foregoing, in the present embodiment, the density pattern 31 is formed only for the density sensor 17 in the center.

More specifically, the adhered amount correction patterns are formed at the position of the position sensor 18 positioned at the center of the image by patches juxtaposed in the sub-scanning direction, for example, in four steps in density for each color. By varying the developing bias voltage and the amount of light of the laser light for each pattern, various adhered amount correction patterns 31 are formed at a given distance in the sub-scanning direction. The patterns are formed the same for all four colors. The reflected light from the adhered amount correction patterns is detected by the position sensor 18, and the image forming apparatus carries out the adhered amount correction based on the detection result of the position sensor 18.

In the positional deviation correction executed by such processing, due to the intermediate transfer belt 5 and the secondary transfer roller 22 being in contact, the color alignment patterns 30 are adhered onto the secondary transfer roller 22. The toner adhered on the secondary transfer roller 22 contacts the rear surface of the sheet when printing, causing a problem of back stains.

Accordingly, while the color alignment patterns 30 are passing through the secondary transfer roller 22, the secondary transfer roller 22 is normally controlled by applying bias in an opposite polarity to the toner so that the toner is not attracted thereto. Even so, however, the toner is adhered because they are physically in contact.

Therefore, cleaning is carried out in which, after the color alignment patterns 30 are passed through, the toner is further separated from the secondary transfer roller 22 and attracted to the intermediate transfer belt 5 side, and is then removed by the cleaning unit. The cleaning is carried out by alternatively applying cleaning bias of the same as and opposite to the polarity of the toner. This is because the toner is sometimes mixed with the toner of an opposite polarity to the original polarity.

The secondary transfer roller 22 can be cleaned by applying the cleaning bias to attract the toner from the secondary transfer roller 22 to the intermediate transfer belt 5 side. However, it is not possible to detect how long it needs to apply the cleaning bias to completely separate the toner adhered on the secondary transfer roller 22. Consequently, the cleaning time is set longer with a margin in consideration of this, thereby causing an increase in user downtime.

To optimize the cleaning time, it only needs to directly detect the amount of residual toner on the intermediate transfer belt 5 attracted from the secondary transfer roller 22 and to end the cleaning when the residual toner becomes not detected. In this case, when the distances from the secondary transfer roller 22 to the position sensors 18 and 19 are shorter, the residual toner can be detected sooner, whereby the cleaning time can be made shorter. Further, when the distance from the secondary transfer roller 22 to the cleaning unit 20 is shorter, the residual toner on the intermediate transfer belt 5 can be removed sooner, whereby the cleaning time can be made shorter.

FIG. 9 is a diagram for explaining the method of detecting the amount of residual toner. When the color alignment patterns 30 are detected by the position sensors 18 and 19 after passing through the secondary transfer roller 22, a first detection waveform 36_pt indicated in FIG. 9 is obtained. In the cleaning, when the residual toner attracted from the secondary transfer roller 22 to the intermediate transfer belt 5 by applying the cleaning bias is detected, a second detection waveform 36_cl is obtained.

With the first detection waveform 36_pt, the crossing points of the threshold line 41 are determined as the edges of the color alignment patterns 30 after passing through the secondary transfer roller 22 and, with the second detection waveform 36_cl, the crossing points of the threshold line 55 are determined as the edges of the residual toner.

FIG. 10 is a flowchart indicating the setting procedure of the threshold level. It is assumed that the RAM 52 stores therein in advance the threshold level 41 for pattern detection and the threshold level 55 for residual toner detection. Such threshold levels 41 for pattern detection in plurality of levels for each toner density, which changes in response to the fluctuation of the apparatus temperature and humidity, are stored in the RAM 52 in advance, and the corresponding threshold level 41 for pattern detection is selected from the stored threshold levels corresponding to the fluctuation of the apparatus temperature and humidity. The threshold level 55 for residual toner detection in two kinds of a first and a second level are stored in the RAM 52 in advance. In other words, the pattern detection threshold levels 41 are prepared in plurality for each toner density, which changes corresponding to the apparatus temperature and humidity, and the residual toner detection threshold levels 55 are prepared in two kinds.

When setting the threshold level, apparatus ambient information of the image forming apparatus PR, i.e., the information of apparatus temperature and apparatus humidity, is obtained first (Step S101). Referring to the stored data in the RAM 52, the pattern detection threshold level corresponding to the apparatus temperature and humidity is selected and set (Step S102).

Then, the threshold line for the color alignment patterns 30 is set (Step S103), and the color alignment patterns 30 of a given number of sets are detected (Step S104). When the detection is finished, the threshold level is changed from the color alignment pattern detection threshold level 41 to the threshold level 55 for residual toner (Step S105). The residual toner detection threshold level in two kinds of the first and the second threshold level are stored in the RAM 52 in advance. The first threshold level indicates that, if the residual toner is not detected at this level, the toner stains on the secondary transfer roller 22 are cleaned to the level not affecting the back stains of the sheet at all. The second threshold level higher than the first threshold level indicates that, if the residual toner is not detected at this level, the toner stains on the secondary transfer roller 22 are cleaned to the level affecting the back stains of the sheet only to some extent. In other words, the first and the second threshold level sets the level whether the back stains of the sheet is affected.

After the threshold level is changed from the threshold line 41 to the threshold line 55 at Step S105, it is checked whether the sheet setting is set as scratch paper (Step S106). If the sheet setting is not set as the scratch paper, the threshold level is set to the first residual toner detection threshold level (Step S107). If the sheet type selection is set as the scratch paper or the like, shortening of the cleaning time has a priority over the back stains and thus the threshold level is set to the second residual toner detection threshold level (Step S108). This completes the threshold level setting operation.

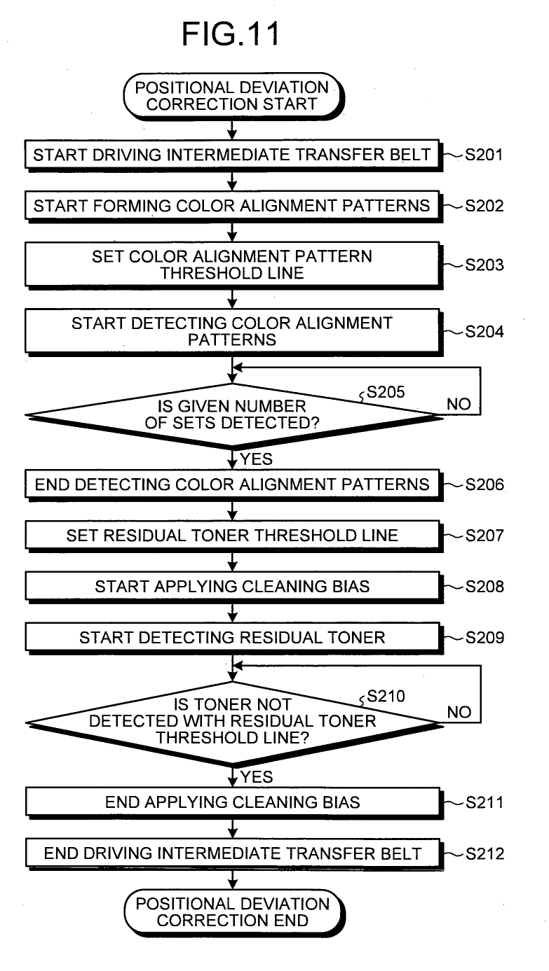

FIG. 11 is a flowchart indicating the procedure of positional deviation correction process. In the correction process, when the drive of the intermediate transfer belt 5 is started (Step S201), the forming of the color alignment patterns 30 is started (Step S202) and the color alignment pattern threshold line is set (Step S203). When the color alignment pattern threshold line is set at Step S203, the detection of the color alignment patterns 30 is started (Step S204).

The CPU 51 detects the pattern edges 42_pt1 and 42_pt2 with the pattern detection threshold level 41 when detecting the color alignment patterns 30. After the color alignment patterns of a given number of sets are detected (Step S205) and the detection of the color alignment patterns 30 is finished (Step S206), the threshold level is reset to the residual toner detection threshold level 55 (Step S207) and the pattern edges (42_c11, 42_c12) of the residual toner are detected during the cleaning operation. The residual tone detection threshold level 55 set here is the threshold level set at Step 5107 or at Step 5108 indicated in FIG. 10.

Then, the applying of the cleaning bias to the cleaning unit 20 is started (Step S208) and the detection process of the residual toner is started (Step S209). The detection of the residual toner is carried out based on the threshold line 55 for residual toner set at Step S207 and, when the edges of the residual toner become not detectable with the threshold line 55 for residual toner (Step S210), the applying of the cleaning bias is finished (Step S211) and the drive of the intermediate transfer belt 5 is finished (Step S212) to complete the positional deviation correction operation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An image forming apparatus, comprising:
an image forming unit that includes a plurality of image carriers arranged juxtaposed along a moving direction of an endless conveying body and forms developer images in different colors in electrophotographic process on the image carriers;
a first transfer unit that transfers the developer images formed on the respective image carriers onto the endless conveying body;
a second transfer unit that includes a rotating body that transfers the developer images transferred on the endless conveying body onto a recording medium;
a plurality of pattern detecting units that irradiate a given developer pattern formed on the endless conveying body with a light beam and detect a state of reflected light from the pattern;
a cleaning unit that applies bias to the second transfer unit to clean developer images adhered to the second transfer unit while the endless conveying body is rotating; and
a control unit that controls each of the units, wherein
the pattern detecting units are arranged between the second transfer unit and the image carrier on the most upstream side from the second transfer unit in a rotation direction of the endless conveying body, and
the control unit changes a cleaning time of the cleaning unit based on a detection result of the pattern detecting units.

2. The image forming apparatus according to claim 1, wherein
the given developer pattern is a positional deviation correction pattern including patterns of a plurality of colors,
the control unit includes a positional deviation amount calculation unit that calculates a positional deviation amount of the positional deviation correction pattern on the endless conveying body in a direction orthogonal to the rotation direction of the endless conveying body, and
the positional deviation amount calculation unit has a first detection threshold value for detecting the positional deviation correction pattern and a second detection threshold value for a front pattern detecting unit to detect a residual positional deviation correction pattern on the endless conveying body after passing the second transfer unit.

3. The image forming apparatus according to claim 2, wherein
the positional deviation amount calculation unit detects a given number of positional deviation correction patterns with the first detection threshold value, and then detects the residual positional deviation correction pattern after passing the second transfer unit with the second detection threshold value.

4. The image forming apparatus according to claim 2, wherein
a plurality of the first detection threshold values is stored in a storage unit in advance, and
the positional deviation amount calculation unit selects the first threshold value corresponding to an ambient condition including temperature and humidity.

5. The image forming apparatus according to claim 1, wherein
the given developer pattern includes a positional deviation correction pattern and a density correction pattern, and
the pattern detecting unit that detects the positional deviation correction pattern is arranged downstream of the second transfer unit in the rotation direction of the endless conveying body, and the pattern detecting unit that detects the density correction pattern is arranged upstream of the second transfer unit in the rotation direction of the endless, conveying body.

6. The image forming apparatus according to claims 1, wherein
the cleaning unit is arranged between the second transfer unit and the image carrier on the most upstream side from the second transfer unit in the rotation direction of the endless conveying body, and
the pattern detecting units are arranged between the second transfer unit and the cleaning unit arranged at the downstream in the rotation direction of the endless conveying body.

7. A non-transitory computer readable storage medium having a cleaning time optimization control program stored therein for optimizing a cleaning time executed by a control unit of an image forming apparatus that includes
an image forming unit that includes a plurality of image carriers arranged juxtaposed along a moving direction of an endless conveying body and forms developer images in different colors in electrophotographic process on the image carriers,
a first transfer unit that transfers the developer images formed on the respective image carriers onto the endless conveying body,
a second transfer unit that includes a rotating body that transfers the developer images transferred on the endless conveying body onto a recording medium,
a plurality of pattern detecting units that irradiate a given developer pattern formed on the endless conveying body with a light beam and detect a state of reflected light from the pattern,
a cleaning unit that applies bias to the second transfer unit to clean developer images adhered to the second transfer unit while the endless conveying body is rotating, and
the control unit that controls each of the units, wherein
the cleaning time optimization control program causing a computer to execute:
changing the cleaning time of the cleaning unit based on a pattern detection result of the pattern detecting units arranged between the second transfer unit and the image carrier on the most upstream side from the second transfer unit in a rotation direction of the endless conveying body.

8. The non-transitory computer readable storage medium according to claim 7, wherein
the given developer pattern is a positional deviation correction pattern composed of patterns of a plurality of colors,
the changing includes calculating a positional deviation amount of the positional deviation correction pattern on the endless conveying body in a direction orthogonal to the rotation direction of the endless conveying body, and
the calculating the positional deviation amount includes calculating the positional deviation amount based on a first detection threshold value for detecting the positional deviation correction pattern and a second detection threshold value for a front pattern detecting unit to detect a residual positional deviation correction pattern on the endless conveying body after passing the second transfer unit.

9. The computer readable storage medium according to claim 8, wherein
the calculating the positional deviation amount includes detecting a given number of positional deviation correction patterns with the first detection threshold value, and then detects the residual positional deviation correction pattern after passing the second transfer unit with the second detection threshold value.

10. The non-transitory computer readable storage medium according to claim 8, wherein
a plurality of the first detection threshold values is stored in a storage unit in advance, and
the calculating the positional deviation amount includes selecting the first threshold value corresponding to an ambient condition including temperature and humidity.

11. The non-transitory computer readable storage medium according to claim 7, wherein
the given developer pattern includes a positional deviation correction pattern and a density correction pattern, and
the pattern detecting unit that detects the positional deviation correction pattern is arranged downstream of the second transfer unit in the rotation direction of the endless conveying body, and the pattern detecting unit that detects the density correction pattern is arranged upstream of the second transfer unit in the rotation direction of the endless conveying body.

12. The non-transitory computer readable storage medium according to claims 7, wherein
the cleaning unit is arranged between the second transfer unit and the image carrier on the most upstream side from the second transfer unit in the rotation direction of the endless conveying body, and
the pattern detecting units are arranged between the second transfer unit and the cleaning unit arranged at the downstream in the rotation direction of the endless conveying body.
